(19) United States
(12) Patent Application Publication
(10) Pub. No.: US 2011/0191260 A1
(43) Pub. Date: Aug. 4, 2011

(54) AUTOMATED TOOL FOR INVESTMENT TECHNOLOGIES

(76) Inventor: Jan Kolbusz, Nedlands (AU)

(21) Appl. No.: 12/600,027

(22) PCT Filed: May 14, 2008
(86) PCT No.: PCT/AU2008/000677

§ 371 Date: Dec. 28, 2009

(30) Foreign Application Priority Data
May 14, 2007 (AU) 2007902549

(51) Int. Cl. G06Q 40/00

(52) U.S. Cl. 705/36 R

(57) ABSTRACT

A method for creating at least one investment strategy, the method including the steps of inputting user data via a user interface to identify a user; utilising said user data to retrieve statistical and reference data relevant to said user from a database; generating at least one investment strategy for the user based on the user data and retrieved statistical and reference data; displaying said at least one investment strategy.

### FIELD OF THE INVENTION

The present invention relates to an automated tool for creating and distributing content, and more particularly to a computer system and method for creating investment strategies.

### BACKGROUND OF THE INVENTION

In today's complex world, individuals face a myriad of financial issues: budgeting income; being adequately insured; establishing and maintaining sound credit; saving and investing for their own retirement; planning their estate; and saving for a variety of life goals. These financial challenges are not restricted to those having more limited monetary means—they exist along the entire socio-economic continuum.

The primary source of assistance to those requiring to engage with the finance and investments industry, is to turn to a financial planner or financial adviser and engage their services. As a result the financial planning market has grown in size and profile, it has also suffered reputation problems due to specific examples of over charging and misrepresentation of the risk associated with specific investments as well as general surveys of advice given deeming a great deal of it to be sub-standard. In addition there is a question of independence and bias as the majority of financial planners in Australia are either employed or have commercial ties through the holders of the license under which they operate, to financial product providers.

The job of a professional financial adviser is to help a client to manage their financial affairs more efficiently and help the client to reach their financial goals sooner. To do this the financial adviser must complete a comprehensive analysis of the client's current situation. The analysis requires a substantial amount of time to be spent by the client in providing information about their current financial status including how much they earn, how much money is spent each week on items like entertainment, food, automobile expenses etc. The financial adviser will then consider alternate strategies which could be put into place to manage the client income, assets and investments more effectively.

In ensuring the client's financial plan is tailored to suit the client needs, the financial adviser takes into account their personal circumstances including their understanding and acceptance of risk, and their desired timeframes for reaching their financial goals. The adviser also considers important factors such as taxation, superannuation and government legislation and how these may impact the client's income and investment structure.

There is a substantial amount of time required to ensure that a financial plan is suited to the client's needs. There are many hundreds of varied finance and investment technology offerings that attempt to inform individuals of one or more options by overlaying their personal circumstances onto the particular option(s). The nature of such systems is that they are only as good as the accuracy and completeness of data going in. Describing a persons personal financial circumstances has to encompass all their sources of income; all their expenses; their assets and their liabilities. Within each of these categories there are sub categories because of different tax requirements and other regulatory requirements. This presents the problem facing all technology in this area; i.e. if it is relatively easy to use, it is because many of the variables that should be taken into account have been omitted, and hence the results are such gross approximations as to render the answers relatively useless—many public websites offering simplistic calculators fall into this category. Alternatively, if the technology does take into account the required variables, then one requires a high level of financial literacy, and systems training and patience, in the first place just to be able to enter in the array of data required.

It is therefore desirable to provide a means and method for generating investment strategies that overcome or alleviate one or more of the above described disadvantages.

The reference to any prior art in this specification is not, and should not be taken as, an acknowledgement or any form of admission that the prior art forms part of the common general knowledge in Australia.

### SUMMARY OF THE INVENTION

According to one aspect, the present invention provides a method for creating at least one investment strategy, said method including the steps of:

a) inputting user data via a user interface to identify a user;

b) utilising said user data to retrieve statistical and reference data relevant to said user from a database;

c) generating at least one investment strategy for the user based on said user data and retrieved statistical and reference data;

d) displaying said at least one investment strategy.

According to a further aspect the present invention provides an information system for creating investment strategies, said system including:

a input device for inputting user data for identifying a user;

a comparator for utilising said user data to retrieve statistical and reference data relevant to said user from a database; and

a display for displaying said at least one investment strategy, said at least one investment strategy being generated based on said user data and said statistical and reference data.

Ideally the database would be a government sponsored database, for example from the Australian Bureau of Statistics.

The advantage of the present invention is the use of a pre-populated database with the required fields based on surveyed averages that are unbiased, familiar and statistically valid. This means that you only need to know someone's average weekly earnings to place them in a quintile and from that you can derive the average wealth and expenditure for that quintile.

Starting with averages or generalizations is a very normal and natural way for people to start describing any new topic. So relating to descriptions of themselves relative to averages is also normal and natural. The averages however, must be based on a population that the individual is familiar with and identifies with. Obviously statistically valid surveys of the Australian population fit this criterion.

Iteratively progressing to a more accurate description by modifying any of the averages is also normal and natural. Because people are used to seeing themselves as variations to a generalization, they are most likely to seek out the variable that most uniquely defines them relative to the group they belong to. After all, we do this in relation to all aspects of our personal situation and characteristics, whether it is our physical characteristics, sporting dispositions, family circumstances, leisure interests or indeed our financial circumstances.

By pre-populating with a set of unbiased averages, the system can generate a set of outputs immediately. The significance of this is that the user can judge for themselves almost immediately what the relevance and value of the output is to them. It is not just the format and the detail of the output (which could be illustrated in a brochure anyway), but that the output is based on something that is broadly representative of the user.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

FIG. 1 is a basic overview of the system in block diagram form according to present invention.

FIG. 2 is a flow diagram showing the major steps in the process according to the present invention.

FIG. 3 is a block diagram of the computer program showing the different steps in accordance with the present invention.

FIG. 4 is a screen shot of the input screen at start up according to the present invention.

FIG. 5 is a screen shot of the first results screen showing a summary of an investment strategy for a selected user according to the present invention.

FIG. 6 is a screen shot of the strategy summary screen for a selected user according to the present invention.

FIG. 7 is a hardware model of the automated tool for investment technologies according to the present invention.

FIGS. 8 to 17 show flow diagrams that describe the generation of an investment strategy and the set of outcomes that are projected and stored for a particular investment strategy according to the present invention.

FIG. 18 is a screen shot of a generated investment strategy and the set of outcomes that are projected and stored for a particular investment strategy according to the present invention.

FIG. 19 is a further screen shot of FIG. 18.

FIG. 20 is a table showing the different outcomes that may be generated according to the core strategies and sub-strategies according to the present invention.

### DESCRIPTION OF PREFERRED EMBODIMENT

The present invention will be discussed hereinafter in detail in terms of the preferred embodiment of a means and method of automating investment strategies according to the present invention with reference to the accompanying drawings. In the following description, numerous specific details are set forth in order to provide a thorough understanding of the present invention. It will be understood, however, to those skilled in the art that the present invention may be practiced without these specific details.

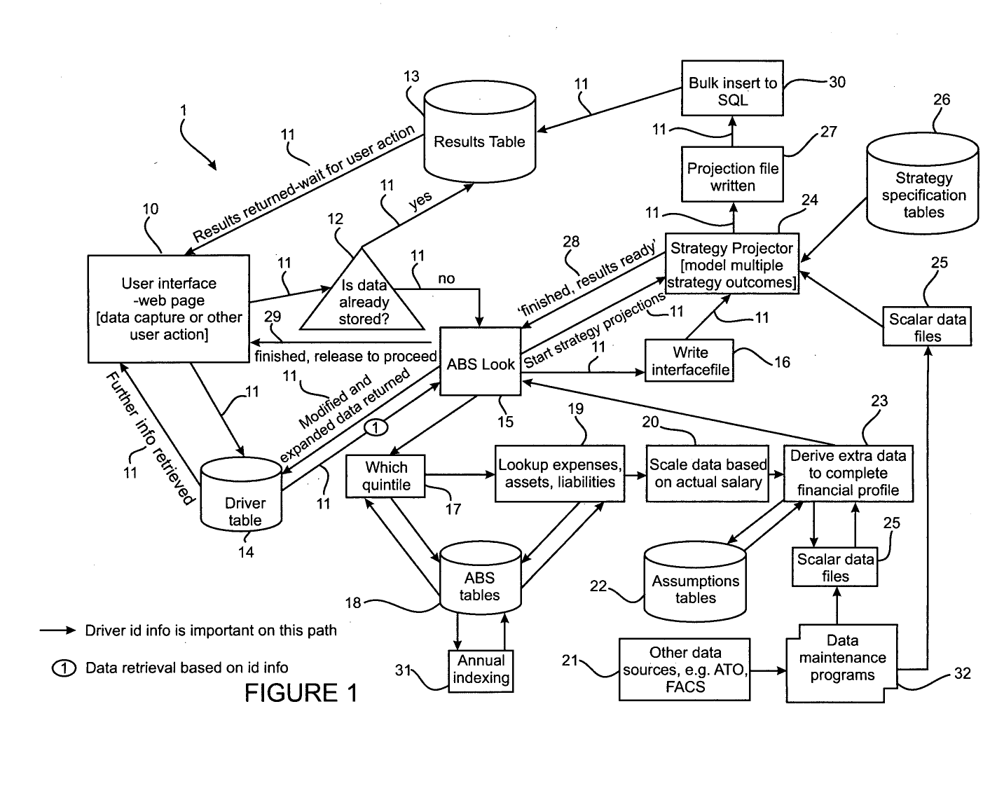

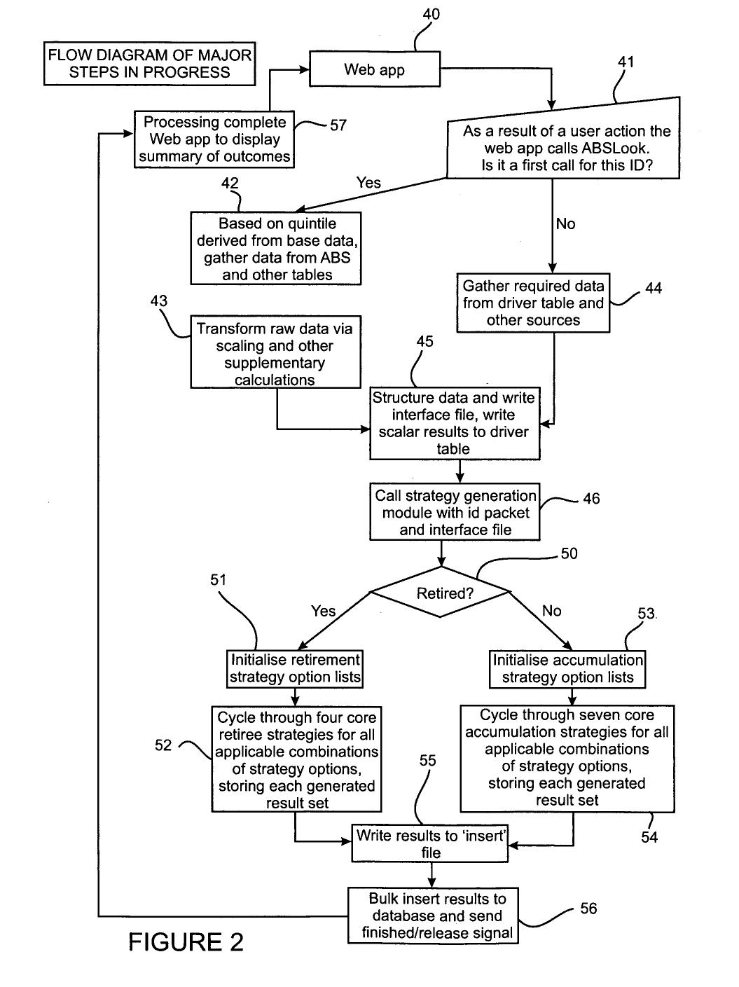

FIG. 1 shows a basic overview of the system 1 in block diagram form, showing the normal path of execution around the diagram, starting with a user action at the leftmost box the user interface 10. The user interface 10 can be a web application consisting of multiple screens and operational aspects not represented here. FIG. 1 deals with the processes for generation of results based on the user actions. With reference to FIGS. 1 and 2, user actions at the user interface 10 can produce two distinct changes in the financial profile 23 that is presented to the strategy projector 24.

One change is one that affects details specific to the user such as assets or loan values. This is part of the ‘general to specific’ refinement mentioned elsewhere in this document. Any change in one element can have wide ranging effects on other elements so regeneration of the entire scope of strategies is required by the strategy projector 24 to show the effect of any change or group of changes.

Another change is at the modelling environment level. This covers parameters not specific to the user individually but to the investment community in general, such as CPI increase rates, investment growth and income rates. These are initially set to default values sourced from the assumptions table 22 and form part of the record in the driver table 14 and the interface financial profile 16 passed to strategy projector 24.

A constant in the process is that when control is passed to the strategy projector 24 a complete financial profile 23 always exists with the process at 15, including 11, 19, 20 and 23, completing the profile enabling the user at 10 to obtain meaningful illustrations of alternatives when they have only minimal and incomplete information available to them at that time.

After decoding the client id information, the strategy projector 24 loads additional environment parameters not exposed to alteration by the user, such as tax scales and superannuation taxation parameters from data files 25 maintained by the data maintenance programs 32. The interface file 16 is then opened and the client parameters from date of birth through to retirement age, gender, partner details and so on are loaded.

Next loaded, from the interface file 16, are scenario specific parameters such as loan to value ratios to be used in loan calculations, calculation date, transition to retirement income stream parameters and property investment value and deposit parameters. The main environment projection details are then loaded from the interface file 16 and relate to at least earnings for different investment types and interest rates for different types of loans and anticipated rates of increase for average weekly earnings and the consumer price index.

Finally, insurance calculation parameters, income asset, liability and expense details are loaded. Also data structures for use in the projections are initialized with this information.

The next step in the process is the processing of the alternatives. The strategy alternatives are structured as core strategies and sub-strategies. Separate sets of core strategies and sub-strategies address alternatives for asset accumulation, retirement income and wealth preservation, protection against insurable risks to life, health and capacity for work, borrowing for investment and other purposes, banking and cash management. In the diagram at step 50 an illustration is made of the selection between core strategy and sub-strategy sets for asset accumulation and retirement. For clarity, the other core strategy and sub-strategy sets are omitted from the diagram. Depending on whether the user has stated that they are retired or not (step 50) a set of core strategies is chosen and the sets of appropriate sub-strategies are populated 51, 53. The projection mechanism takes these lists and cycles through the core strategies for all the applicable (for example sub-strategies involving a partner would not be applicable for a single person) combinations of sub-strategies 52, 54.

The core projection mechanisms for retiree and accumulation strategies are separate but have some things in common. One important such item is the ‘closed loop of cash’ concept, where the effect of shortfalls or surpluses of cash in a particular projection year, and where possible the timing of the events that lead to them, are reflected in the starting position for the following year. This is distinctly different from the majority of models available that project one particular investment or strategy at a time.

Another common item which the core projection mechanisms for retiree and accumulation strategies have in common is the careful assessment of the effect of changes in cash flow levels on income tax aspects such as levies and rebates that might be payable or receivable respectively. In the case of retirees this extends to events such as the passing of age pension eligibility age.

Detailed results are recorded for each investment, debt and cash flow sector for each projection year and these are recorded and made available to the subsequent processes through the insert file 55 initially and the results database 13 ultimately via process 56. Because the identity packet uniquely identifies the user and the combination of parameters used in the strategy projections, all such results sets remain available to the user interface 10 for the duration of the modelling session.

The pathways 11 in FIG. 1 are transactions that are dependent on an identity packet that is passed along those paths 11. As multiple sets of transactions can be at various stages at any time, the identity packet is essential.

On a user action at user interface 10 the interface uses a built in process to determine whether the results required are already available. This is represented by the triangular decision symbol Is data already stored? 12. If the data should be available, the database results table 13 is interrogated using the identity packet and results returned to the presentation processes. If new results are required, details are stored in the driver table 14 then an instance of ABSlook 15 is created using the identity packet. ABSlook 15 first looks up the stored information from driver table 14 then proceeds in a sequential manner to build a financial profile of the user. The financial profile is then passed to an interface file 16 for results generation. The sequence followed is described in more detail below.

Step one in the process is to determine which quintile 17 the user occupies. Using the salary retrieved from driver table 14 the program derives a population quintile for the user by reference to information in ABS tables 18 database. Using the quintile and other tables in the same database the program obtains an assets/liabilities/expenditure profile 19 for the user. This is then scaled 20 linearly from the midpoint salary of the quintile using the actual salary input at the user interface 10.

Using various data files 21 and the assumptions table 22 for information on taxation and other data items, the program performs other calculations such as income tax and loan repayments and makes assumptions in areas where information is not available in the driver table 14 to complete the base ‘now’ financial profile 23 to be used for building strategies.

ABSlook 15 then writes the interface file 16 (a text file on the server, not at this stage encrypted), writes information back to the driver table 14, and triggers an instance of strategy projector 24 passing the identity packet. Using the interface file 16 and scalar data files 25 for the many environmental data items needed to complete the calculations, coupled with the list of strategies to be examined from the strategy specification tables 26, the strategy projector 24 produces results sets for each strategy.

These results are written to a projection file 27 in text format suitable for bulk insertion using the identity packet and bulk insert to SQL 30, into the results table 13. On completion of these steps, the strategy projector 24 sends a finish signal 28 to ABSlook 15 which completes its logging tasks and in turn sends a finish release signal 29 to the user interface 10, which then knows that the results are available and applies the presentation rules to present the data retrieved, using the identity packet, from the results table 13 database and for singular items, from the driver table 14.

Preferably the driver table 14 holds information supplied by the user and supplementary derived or assumed items that form part of the financial profile, where they need to be reflected at the user interface 10 and is referenced using the identity packet.

Preferably the ABS tables 18 and their maintenance, such as annual indexing 31, are databases from the Australian Bureau of Statistics or similar database used in other countries. However, a database other than one from the Australian Bureau of Statistics may be utilised. The idea is that the database would have pre-populated fields which would allow a profile of a person to be built based on some basic information of the user. This description will follow the preferred method of using the Australian Bureau of Statistics database.

To deliver the starting point for the strategy projector 24 the user is required to input data about their financial situation through the user interface 10. This information preferably includes age and salary of the user and is used to reference a table of data derived from ABS publications 6554.0—‘Household wealth and wealth distribution—Australia’— and 6535.0—‘Household Expenditure Survey—Australia’. Since both of these documents present data relating to the 2003/04 financial year, the derived data is indexed by movements in various indices listed below, on an annual basis, to the most recent end of financial year.

The annual salary entered by the user is the most significant item used, as it is the reference that gives us a quintile and thus a financial position ‘shape’.

The annual salary entered is compared to the quintile mid points in the ABS publication 6554.0, and then indexed to the most recent end of financial year by using movements in average weekly earnings—ABS publication 6302.0—‘Average Weekly Earnings—Australia’. As the release of this publication for each quarter does not exactly coincide to the end of the quarter (being for quarters ending February, May, August and November) a similar approach to that used by the ATO in its indexing of superannuation limits has been adopted, using the February publication for March quarter, May for June quarter and so on. There is also a delay of some weeks after the end of each quarter in the release of these figures.

Whilst the present invention prefers to develop a user's profile based on the annual salary of the user, an alternative arrangement could use for example professions, ages, postcodes, or combinations of such fields.

From the wealth and expenditure surveys we derive information for assets and liability values and for spending. In addition, since at that point we do not have data on children and marital status we assume the user is married with two children, triggering the calculation of family payment benefit, which mainly affects those in the lower income brackets.

Spending figures are brought up to the most recent financial year by use of the ABS publication 6401.0—‘Consumer Price Index—Australia’. In using this and other publications for indexing purposes the data item used is the weighted average for the capital cities.

For assets and liability values, the values of the home and the associated borrowings have been adjusted by use of figures from ABS publication 6416.0—‘House Price Indexes—Eight Capital Cities’. Given the absence of other closely matching indices, other assets and liability values have been adjusted using the same index to maintain relativities (the financial position ‘shape’). This starting position is adjusted by the user to suit their actual situation.

Finally, since the Wealth and Expenditure surveys only contain five sets of data, for the quintile mid points, we use the nearest midpoint to the salary entered as the reference for the quintile to use for the base data, then scale all the data items by the ratio of salary entered to quintile midpoint selected.

Preferably the data maintenance programs 32 are used to maintain data files that include essential information such as income tax rates, superannuation environment parameters, Average Weekly Ordinary Time Earnings (AWOTE) and Consumer Price Index (CPI) index values, life expectancies, social security parameters and benefit rates and similar. They are maintained separately based on information of changes from ‘Other data sources’ such as the Australian Taxation Office, the department of Family and Community Services (FACS), the passage of legislation by federal parliament and similar sources.

Preferably the assumptions table 22 includes particularly default economic change assumptions such as investment growth and income, inflation for prices and income, interest rates on loans etc. for three outlooks being ‘positive’, ‘neutral’ and ‘negative’ as well as other calculation parameters that are subject to occasional change.

Preferably the strategy specification tables 26 are accessed by both the strategy projector 24 and the user interface 10 and contain reference information on strategies and outlines of the aims of those strategies, details of steps needed to implement those strategies and other information.

FIG. 2 is a flow diagram showing the major steps in the process according to the present invention. A web application 40 (also referred to in FIG. 1 as the user interface 10) consisting of multiple screens and operational aspects, prompts the user for an input. As a result of a user action the web application 40 at step 41 accesses the ABSLook database 15 and determines whether the user is a first time user (only basic data present to identify user) or if the user has previously logged on.

After a user first invokes the system then:

Step 42:

Using the information input by the user the program determines the quintile for the user by accessing the ABS tables 18 and from other tables in the same database the program obtains an assets/liabilities/expenditure profile for the user.

Step 43

The raw data is transformed, scaled and any other supplementary calculations are carried out before the data is supplied to the write interface file 16.

If the user has previously used (full financial information has previously been made available) the system 1 then:

Step 44

The program gathers the information already received and related to this user from the driver table 14 and uses this previously gathered information in building the financial profile for the interface file 16.

Step 45

The raw data received from step 43 or the information already received from step 44 is now structured and written to the write interface file 16, at the same time scalar results are sent to the driver table 14 for latter reporting through the user interface 40.

Step 46

With the data provided by the write interface file 16 and scalar data files 25 an identification packet and interface file 16 generates a call for the strategy projector 24.

Step 50

Is the user retired, if yes:

Step 51

The retirement strategy option lists are initialized.

Step 52

Cycle through four core retiree strategies for all applicable combinations of strategy options, and storing each generated result set in the strategy projector 24.

Is the user retired, if no:

Step 53

The accumulation strategy option lists are initialized.

Step 54

Cycle through seven core accumulation strategies for all applicable combinations of strategy options, storing each generated result set in the strategy projector 24.

Step 55

Write the results from either step 52 or 54 to the bulk insert file 30.

Step 56

Bulk insert results file 30 is then saved to results table 13 and the finished release signal is sent from ABSLook 15 to the user interface 10.

Step 57

The processing is now complete and the web application 40 displays the summary of the outcomes.

It is also now possible for the user to amend or alter the pre-populated data, and the system will then regenerate investment strategies based on the amended data. In this way a user can ensure the data best reflects reality. An example of the type of pre-populated data which may be altered or amended includes but is not limited to current value of assets held, ie house, superannuation, investment properties, non-super investment portfolio, cash, personal assets and for all other cash and superannuation, is there any loan and principal outstanding.

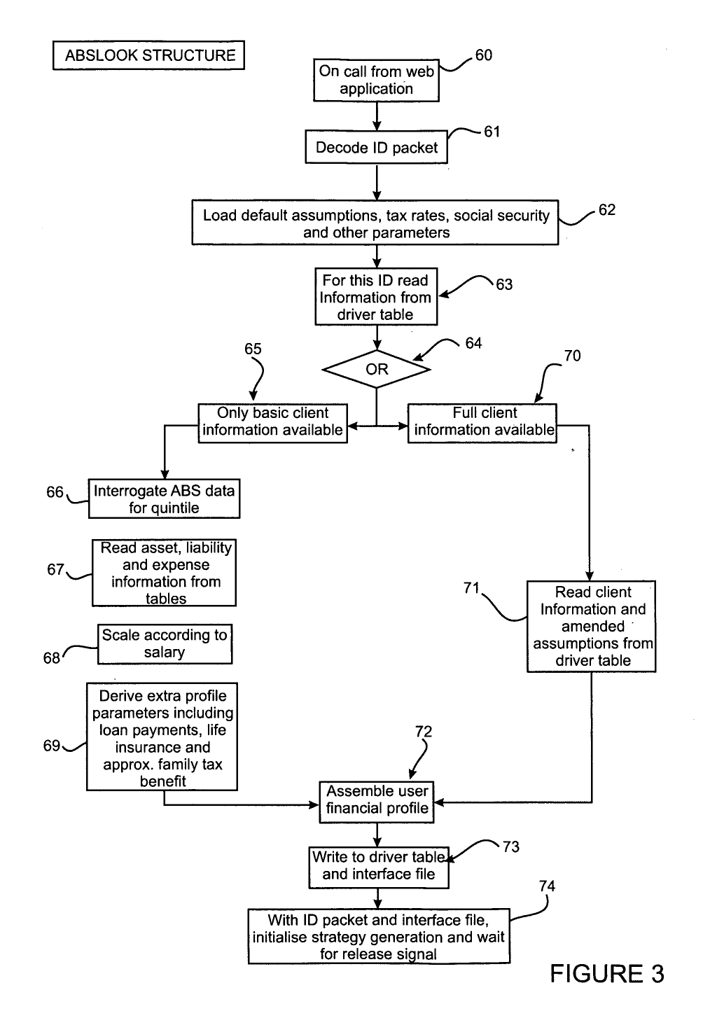

Referring to FIG. 3, a block diagram is shown of the computer program structure showing the different steps in accordance with the present invention. It should be understood that the present invention can be implemented in several different programming languages and is not limited to any specific programming language.

Step 60

As a result of a user action the web application 40 at step 60 accesses the ABSLook database 15 and produces an ID packet.

Step 61

The ID packet is decoded.

Step 62

Default assumptions, tax rates, social security and other parameters are loaded to the system 1.

Step 63

For the ID packet decoded in step 61 information from the driver table 14 is loaded for this particular user.

Step 64

An Or gate is used to determine what information is available for this particular user.

If only basic information about user is available then step 65:

Step 66

The ABS data is interrogated to determine the quintile for this user.

Step 67

For this quintile the asset, liability and expense information is read from the ABS tables 18.

Step 68

The data provided in step 67 is scaled according to the salary of the user.

Step 69

Any extra profile parameters are derived, for example, loan payments, life insurance and approximate family tax benefit.

If full user information is available then step 70:

Step 71

All user information is read from the driver table 14 and any amended assumptions are also read from the driver table 14.

Step 72

A user financial profile is assembled from either steps 69 or 71.

Step 73

The information is written to the driver table 14 and the write interface file 16.

Step 74

With the ID packet and the write interface file 16 a strategy generation is initialized and the program waits for a release signal before in turn sending a finished signal to the user interface 10 which displays the summary of outcomes for this particular user.

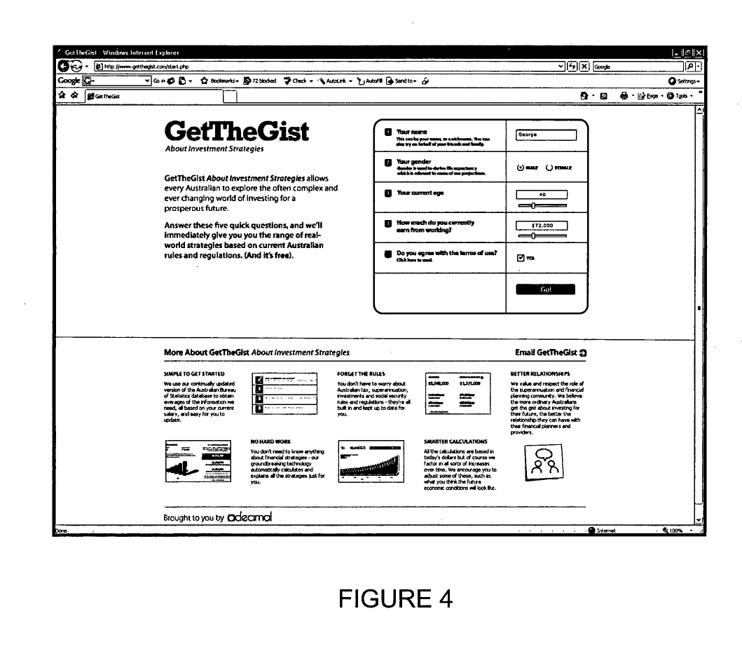

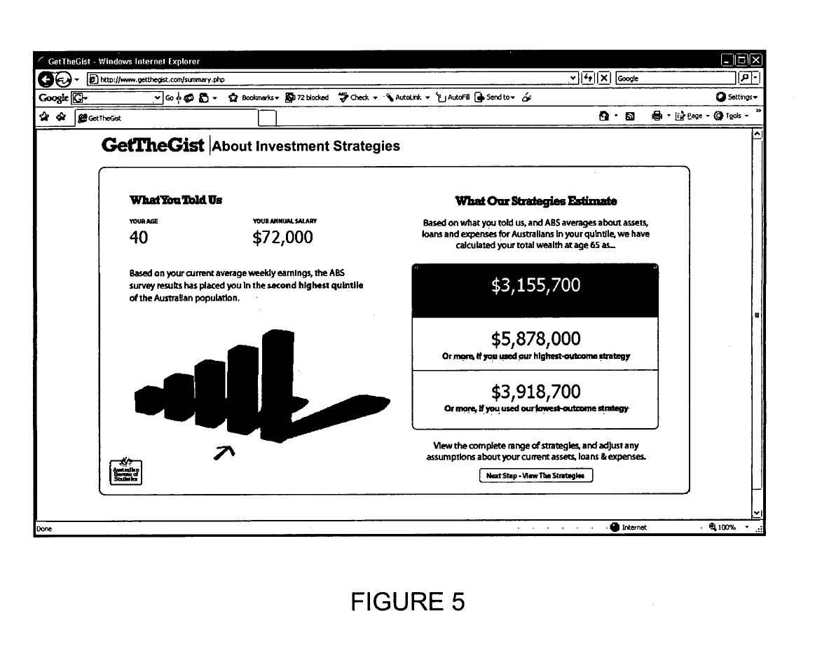

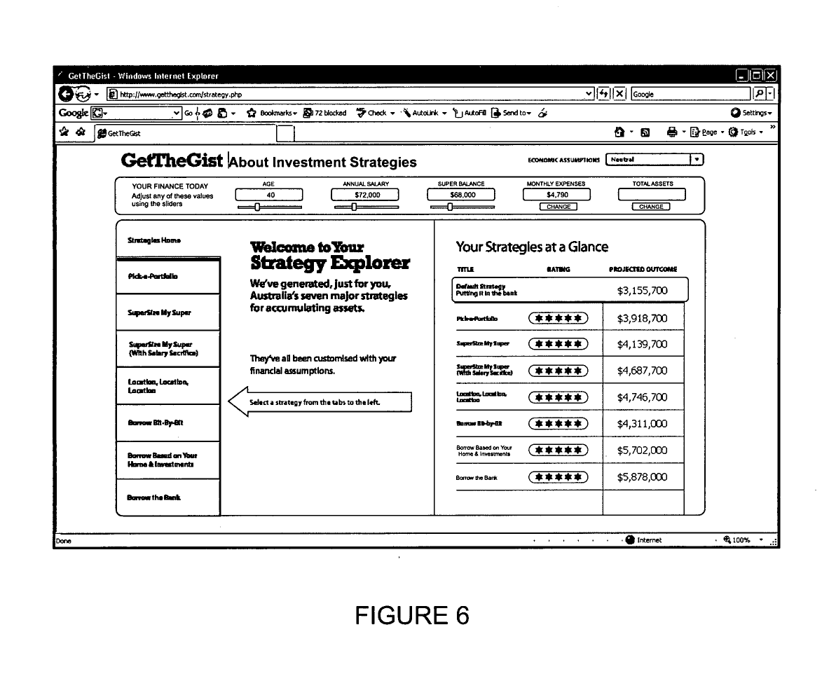

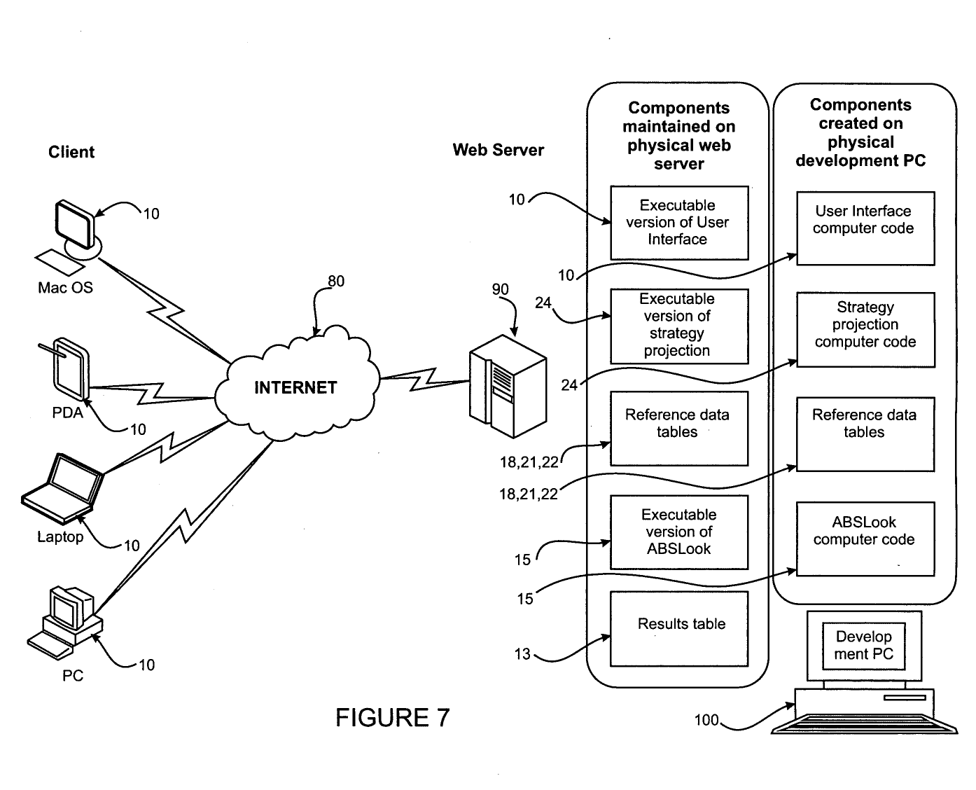

To further illustrate the relationship between the automated tool for investment technologies system 1, its inputs and outputs, and various data sources to which it is coupled, FIG. 7 shows an embodiment of the present invention, the hardware model of the system 1 and its associated data sources. In FIG. 7, items having like reference numbers as items in FIGS. 1-6 are substantially similar and perform substantially similar functions.

The user interface 10 is a web application consisting of multiple screens and operational aspects. The user interface 10 may be implemented on such devices as shown in FIG. 7 (i.e. personal computer, laptop computer, personal digital assistant (PDA) or an Apple Macintosh (Mac) computer), which are linked to the world wide web (internet 80) by a number of methods (i.e. dial up connection, ADSL or ADSL 2, wireless, cable or satellite connection). The interface 10 is then connected via the world wide web 80 to the web server 90.

The web server 90 maintains the following components utilised in order to produce the investment strategies:
Executable version of the user interface 10
Executable version of the strategy projection 24
Reference data tables 18, 21, 22
Executable version of ABSLook 15
Results table 13

A development personal computer 100 is also used in order to provide the computer code including the application software, programming software and system software. The development computer 100 includes the following components:
User interface computer code 10
Strategy projection computer code 24
Reference data tables 18, 21, 22
ABSLook computer code 15

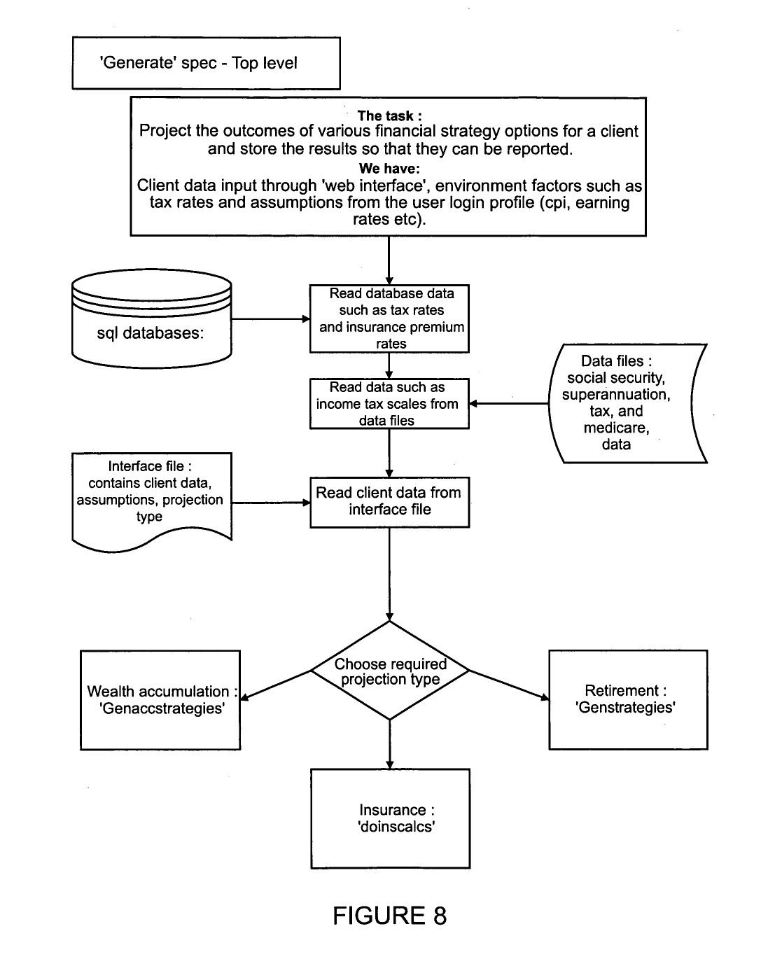

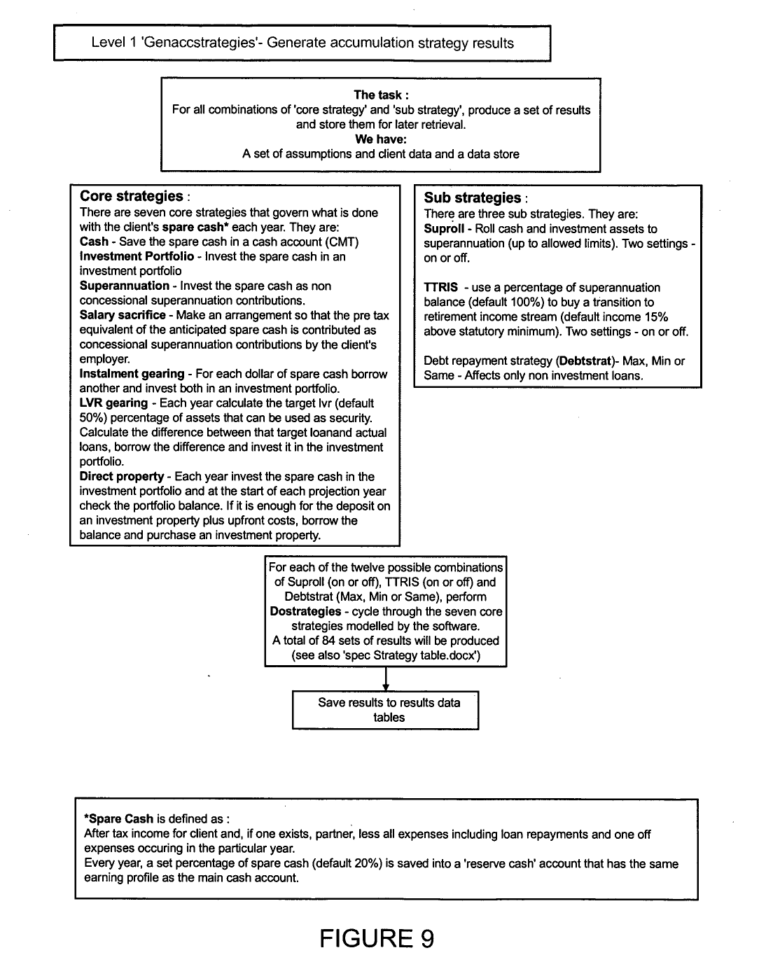

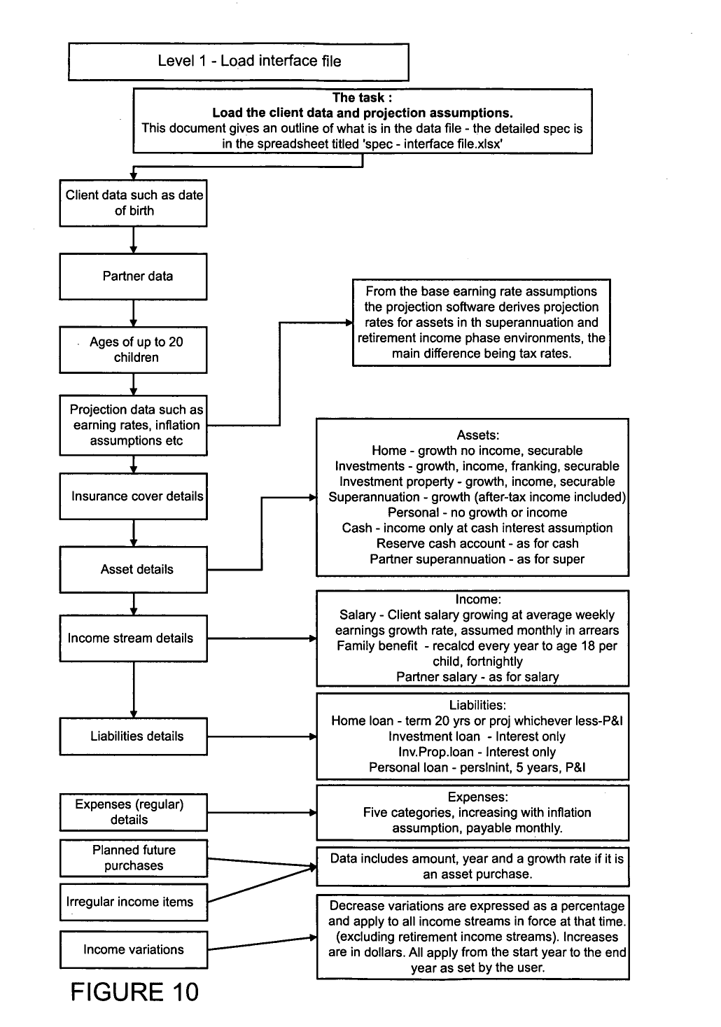

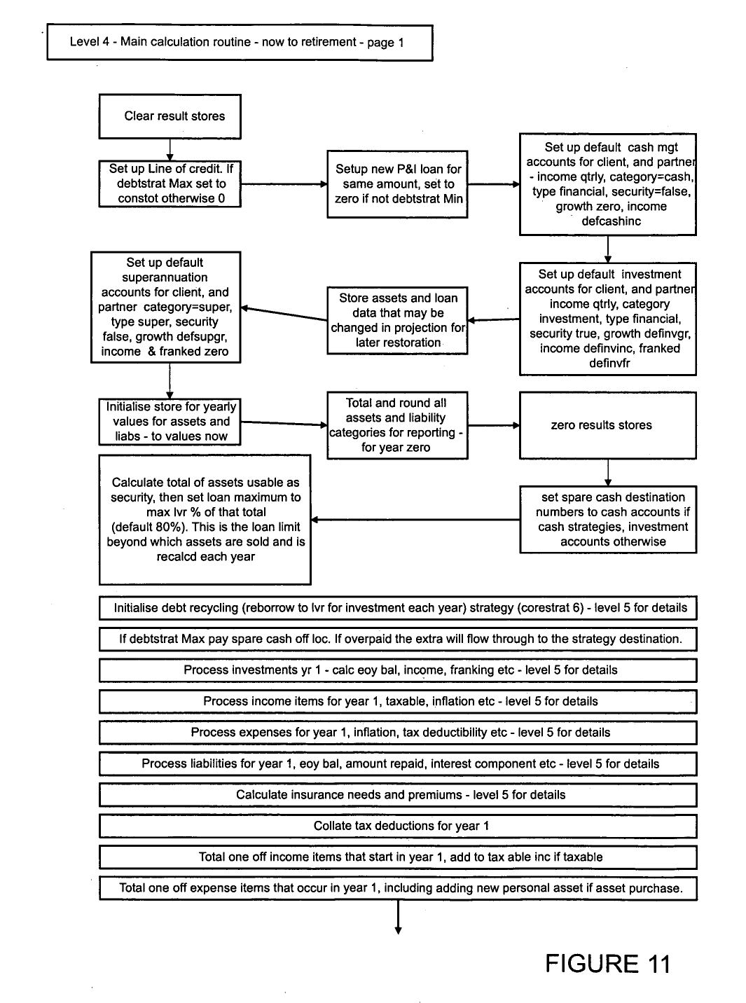

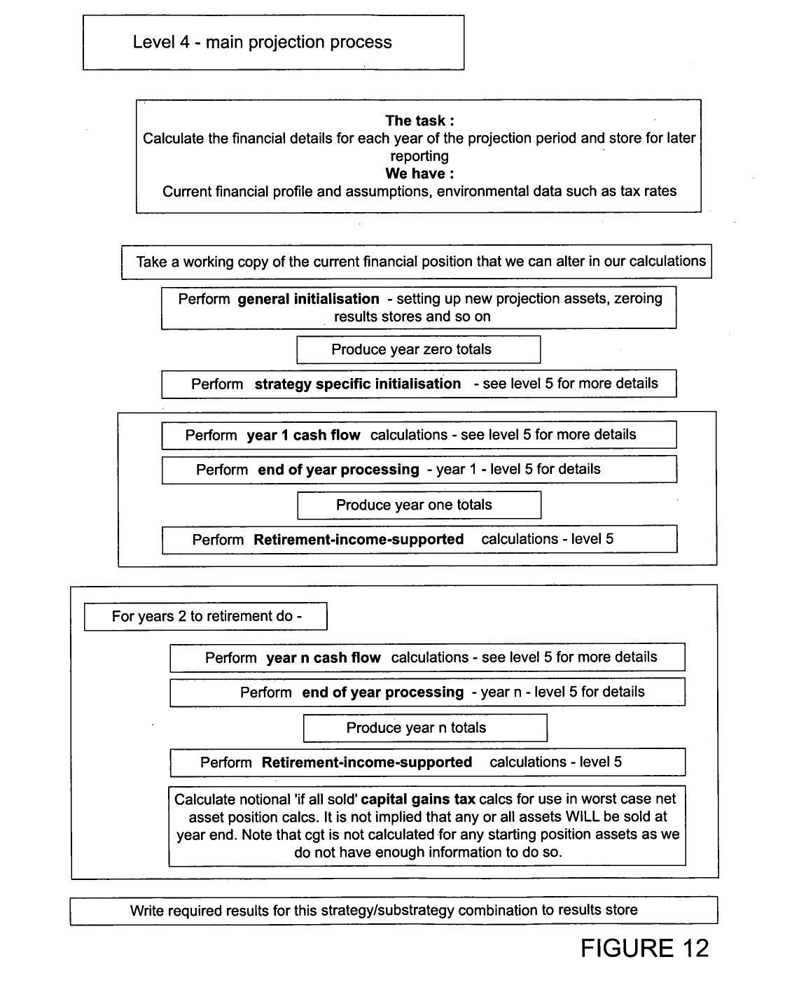

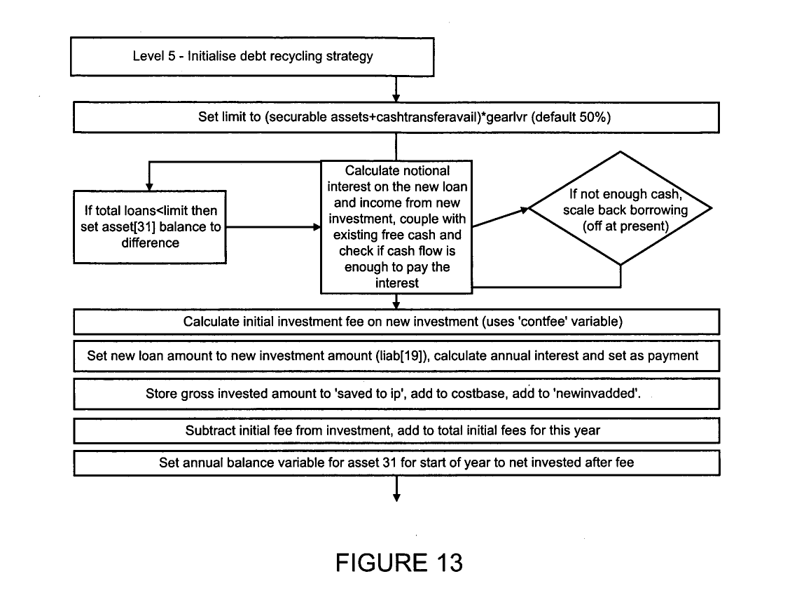

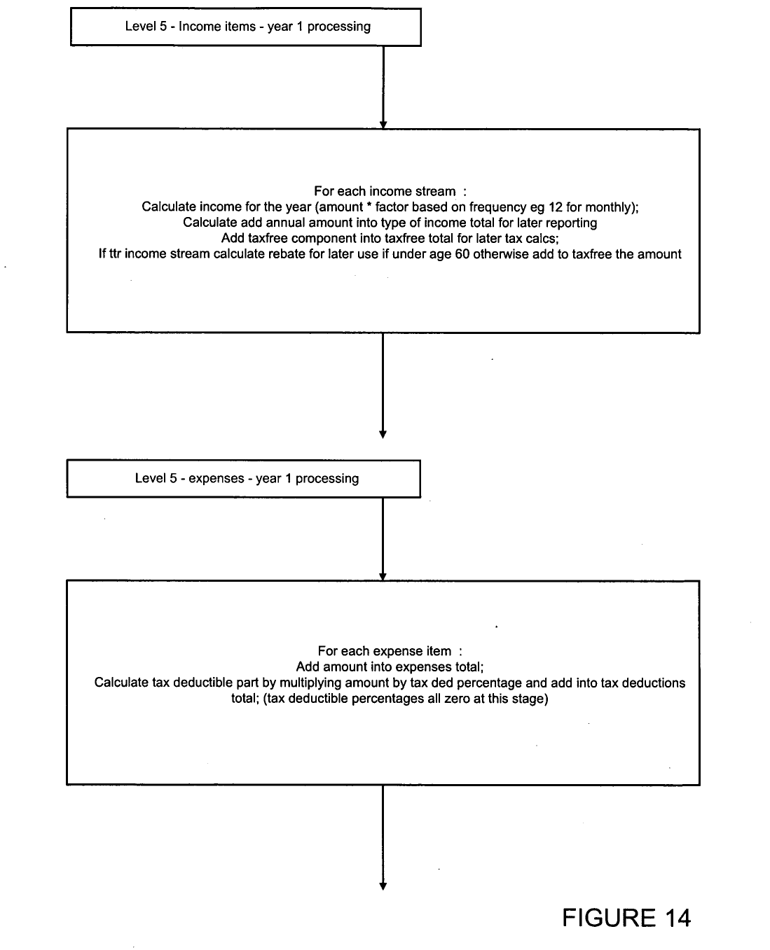

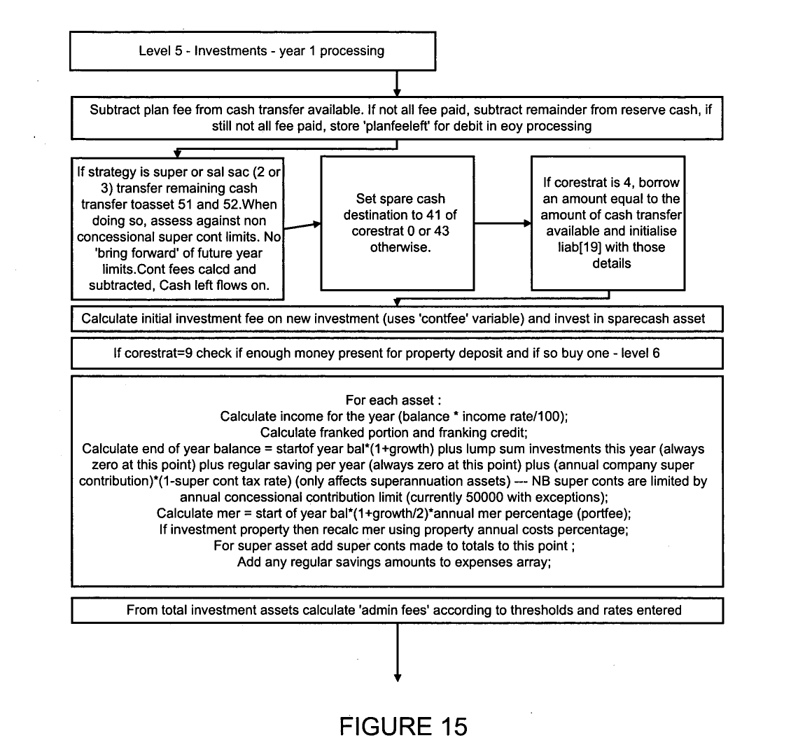

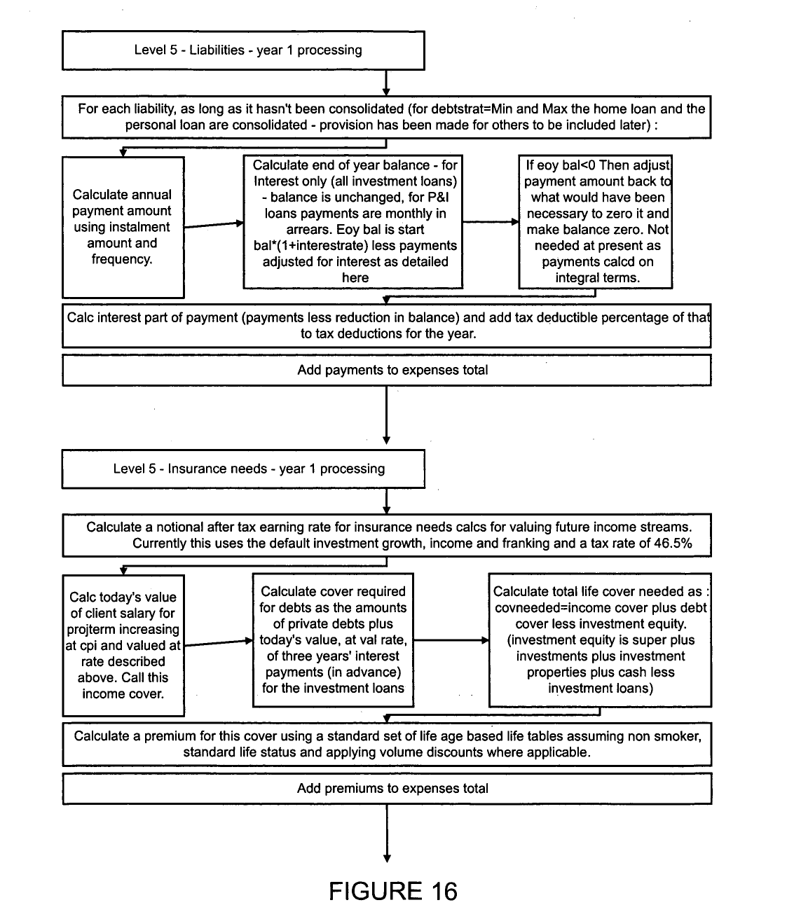

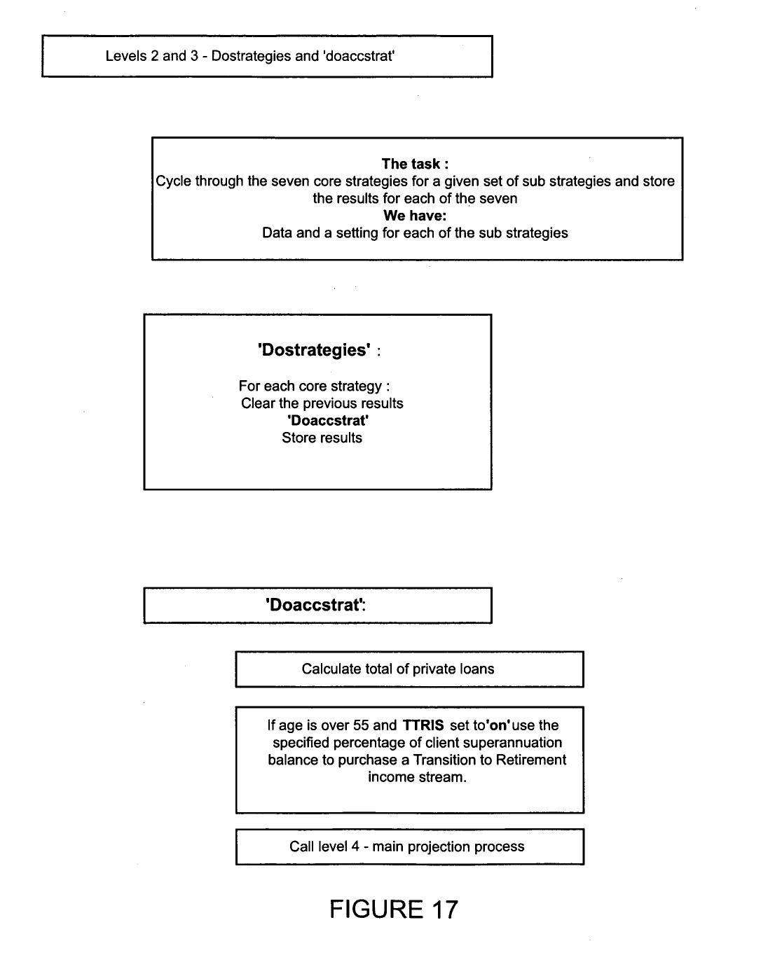

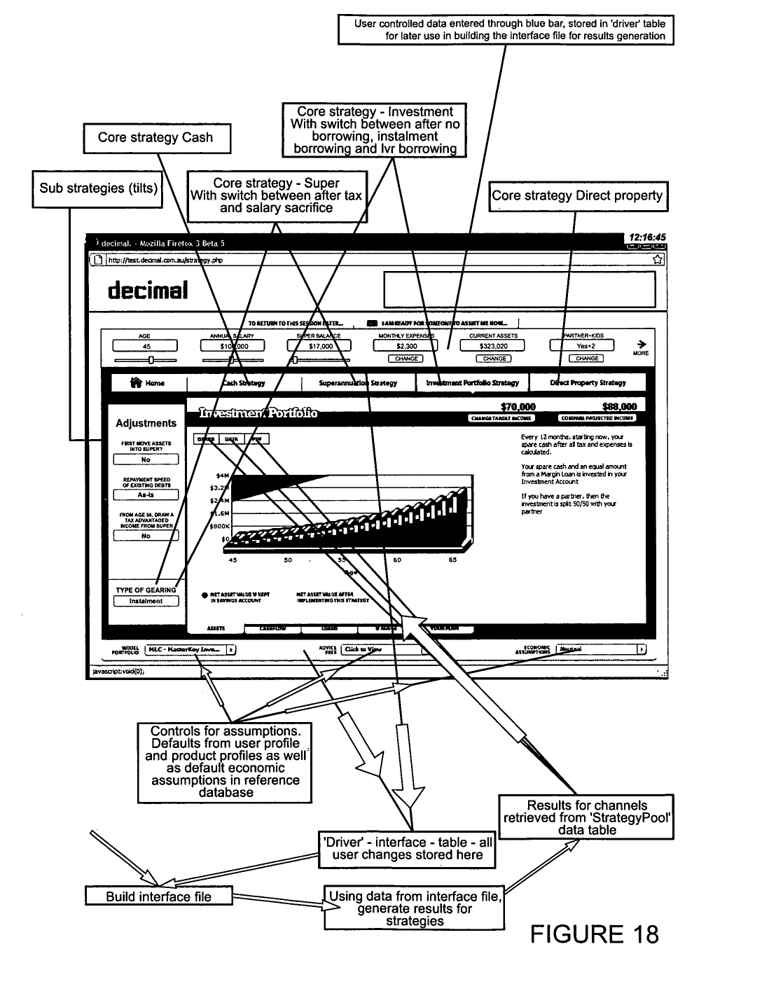

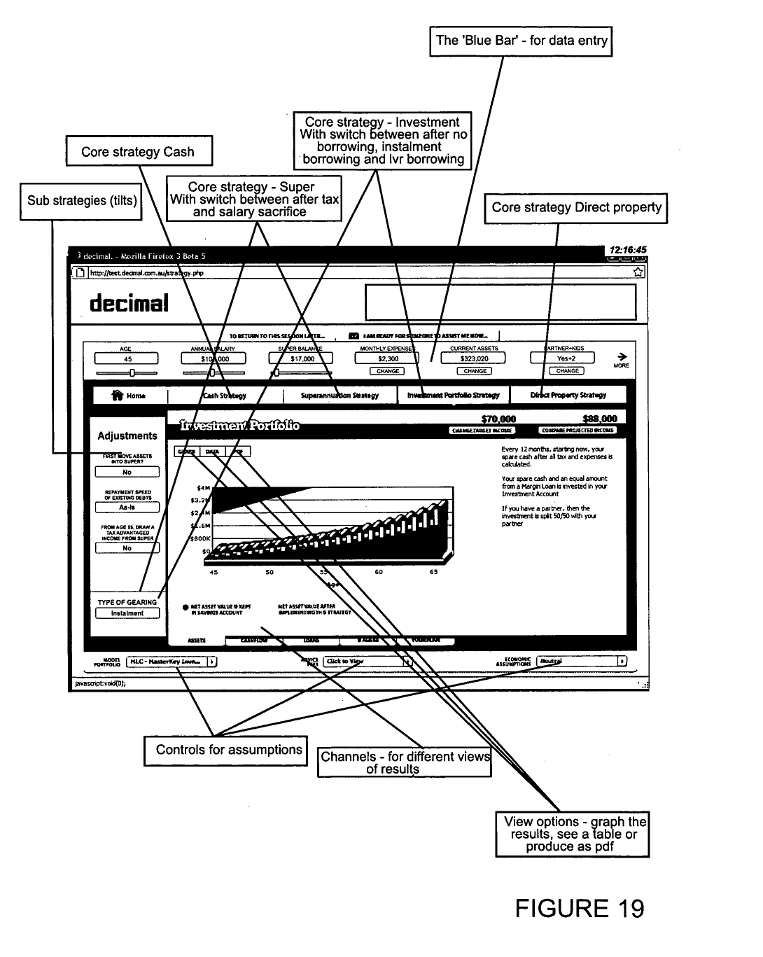

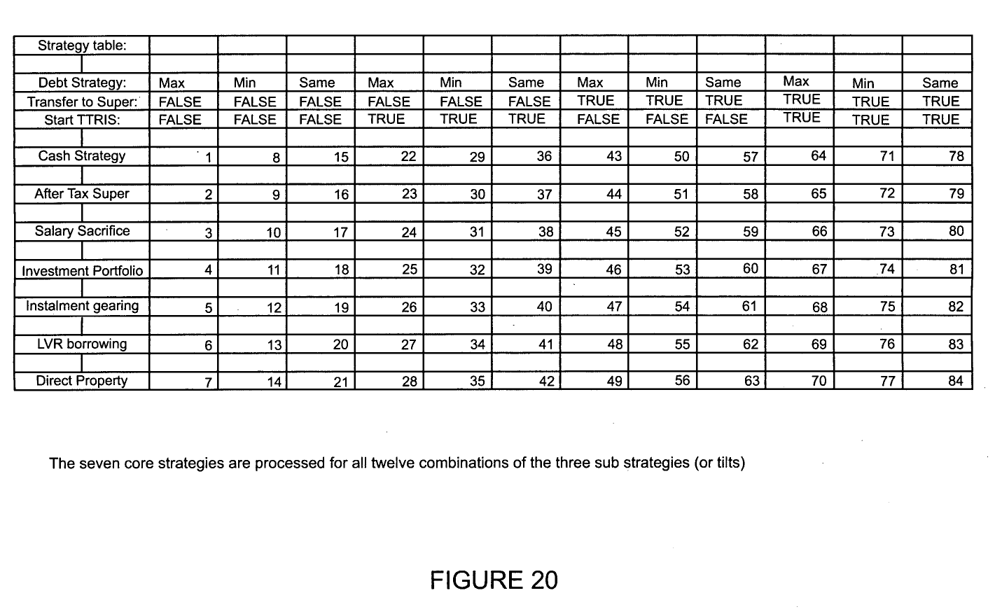

Referring to FIGS. 8 to 17, flow diagrams describing the generation of an investment strategy and the set of outcomes that may be projected and stored for a particular investment strategy. The figures show the various financial strategy options that may be available to a user and also once generated the financial strategy options may be stored for future use by the user or a professional as described below.

The present invention is equally useable and beneficial for general consumers and financial advisors and other professionals. The system may also provide a user with a unique key so that they can come back to the system at a later time and continue where they left off.

Because both consumers and professionals can use this system in one arrangement, a consumer only need forward their unique key (phone or email or any similar means) to a professional to allow a professional to take over on their behalf if this is desired.

This provides a solution to a user being able to self-start their financial planning because the first part of financial planning is best done by the consumer (i.e. describing themselves) and the assessment of the alternative strategies to the professional. Of course a consumer may elect to use the system for themselves, without the involvement of a professional, or a professional could use the system wholly on behalf of a client.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1. A method for creating at least one investment strategy, said method including the steps of:
a) inputting user data via a user interface to identify a user;
b) utilising said user data to retrieve statistical and reference data relevant to said user from a database to generate a user profile;
c) generating at least one investment strategy for the user based on said user profile;
d) displaying said at least one investment strategy.

2. The method of claim 1 wherein said database is created from surveys of the public.

3. The method of claim 1, wherein said user is able to alter said statistical and reference data.

4. The method of claim 1, further including displaying an itemized list of steps to implement said at least one investment strategy.

5. The method of claim 1, further including providing said user with information as to monetary outcomes generated by said at least one investment strategy.

6. The method of claim 1, wherein said database is the Australian Bureau of Statistics database or equivalent international database.

7. The method of claim 1, wherein said user data used to identify said user includes:
a) age of said user;
b) gender of said user;
c) annual salary of said user.

8. The method of claim 1, wherein said comparison of said user data with said statistical and reference data from said database places said user in a quintile derived from the average wealth and expenditure for that quintile.

9. The method of claim 1, further including a core projection mechanism, said core projection mechanism includes the effect of shortfalls or surpluses of cash in a particular projection year are reflected in a starting position for the following year.

10. The method of claim 1, wherein once said user has created at least one investment strategy, a unique identifier is generated which is used to identify and link said user to the at least one investment strategy.

11. The method of claim 10, wherein said unique identifier may be passed to an investment professional to allow said professional to further modify said at least one investment strategy.

12. An information system for creating investment strategies, said system including:
a input device for inputting user data for identifying a user;
a comparator for utilising said user data to retrieve statistical and reference data relevant to said user from a database to generate a user profile; and
a generator to generate at least one investment strategy for the user based on said user profile;
a display for displaying said at least one investment strategy, said at least one investment strategy being generated based on said user profile.

13. A system as claimed in claim 12 wherein said database is created from surveys of the public.

14. A system as claimed in claim 12 wherein said user is able to alter said statistical and reference data.

15. The system of claim 12, further including displaying an itemized list of steps to implement said at least one investment strategy.

16. The system of claim 12, further including providing said user with information as to monetary outcomes generated by said at least one investment strategy.

17. The system of claim 12, wherein said database is the Australian Bureau of Statistics database or equivalent international database.

18. The system of claim 12, wherein said user data used to identify said user Includes:
a) age of said user;
b) gender of said user;
c) annual salary of said user.

19. The system of claim 12, wherein said comparison of said user data with said statistical and reference data from said database places said user in a quintile derived from the average wealth and expenditure for that quintile.

20. The system of claim 12, further including a core projection mechanism, said core projection mechanism includes a closed loop for cash concept where the effect of shortfalls or surpluses of cash in a particular projection year are reflected in a starting position for the following year.

21. The system of claim 12, wherein once said user has created at least one investment strategy, a unique identifier is generated which is used to identify and link said user to the at least one investment strategy.

22. The system of claim 21, wherein said unique identifier may be passed to an investment professional to allow said professional to further modify said at least one investment strategy.

23. (canceled)

24. (canceled)

25. A method for creating a user profile, said method including the steps of:
b) inputting user data via a user interface to identify a user;
b) utilising said user data to retrieve statistical and reference data relevant to said user from a database to generate said user profile;
